(19) United States
(12) Patent Application Publication
(10) Pub. No.: US 2007/0137367 A1
(43) Pub. Date: Jun. 21, 2007

(54) Cushioned bearing shell for manual gearshift lever

(75) Inventors: Dominik Papa, Dassel (DE); Martin Knagge, Seesen (DE); Dirk Brucke, Bad Gandersheim (DE)

Correspondence Address: WILLIAM COLLARD;COLLARD & ROE, P.C., 1077 NORTHERN BOULEVARD, ROSLYN, NY, 11576, US

(73) Assignee: Teleflex Automotive Germany GmbH

(21) Appl. No.: 11/397,093

(22) Filed: Apr. 4, 2006

(30) Foreign Application Priority Data
Nov. 29, 2005 (DE) 10 2005 057 216.2

(51) Int. Cl. F16H 59/04

(52) U.S. Cl. 74/473.34

(57) ABSTRACT

A cushioned bearing shell for mounting the manual gearshift lever in the gearshift housing of motor vehicles includes the manual gearshift lever, which can pivot around the bearing ball mounted in the bearing shell. The assembly includes two half-shells encircling the bearing ball that are split horizontally to the shaft of the manual gearshift lever and are cushioned, two split bearing shells encircling the bearing ball with half shells, which are split essentially lengthwise of the shaft of the gearshift lever, and a gearshift housing in which the split bearing shells are fitted with the shift lever, the bearing ball, and the half-shells, and which holds the split bearing shells firmly together.

### CROSS REFERENCE TO RELATED APPLICATIONS

Applicants claim priority under 35 U.S.C. §119 of German Application No. 10 2005 057 216.2 filed on Nov. 29, 2005.

### BACKGROUND OF THE INVENTION

1. Field of the Invention

The present invention relates to a cushioned bearing shell for mounting a manual gearshift lever in the gearshift housing of motor vehicles, which pivots around the bearing ball mounted in the bearing shell. The invention can be used wherever manual gearshift levers are to be mounted in the bearing box, and this mounting may be done quickly and easily with little effort.

2. The Prior Art

Bearing shells for manual gearshift levers for vehicles are known in various designs.

DE 103 25 536 describes a multi-part adjustable bearing ball for shift mechanisms and selector mechanisms in vehicles. With this bearing ball, the position of the shift lever is adjustable relative to its mount. Using this method, tolerances in the installation of the shift lever between the bearing shell and the shaft of the lever can be compensated for, easily and reliably.

DE 692 10 981 T1 describes a shift lever mount in which the bearing ball is encircled by parts that can be individually clamped into one another and is located in a bearing box that can be put together. The bearing ball consists of ball components split lengthwise of the gearshift rod that can be clamped into one another. The bearing itself consists of components that are screwed together with a frame. Thus simple installation is not directly possible because of the number of components and the complicated forms of some of them.

EP 0 792 768 A1 describes a bearing shell with a manual gearshift lever and a bearing ball whose surrounding components are screwed to one another. This method also has a number of components, so that installation is complicated and time-consuming.

All three methods also have the problem that the manual gearshift lever for motor vehicles can be installed and disassembled only with high expenditure of time and materials. This problem arises because of the multiplicity of operating steps and different tools. It is important especially for manufacturers of manual gearshift levers with cushioned bearing shells, but also for installers, for quick installation and disassembly of the components to be possible with little effort. Shift connections are of just as little benefit here as the exact setting of connections.

### SUMMARY OF THE INVENTION

It is therefore an object of the present invention to provide a system with which it is possible to install and disassemble the manual gearshift lever and the bearing shell with little effort in a simple manner.

These and other objects are achieved by a cushioned bearing shell for mounting the manual gearshift lever in the gearshift housing of vehicles according to the invention. Beneficial refinements of the invention are discussed below.

The system according to the invention has two half-shells that encircle or surround the ball of the manual gearshift lever, which can be made of metal like the shift lever itself. These half-shells split perpendicular or horizontal to the shaft of the shift lever are slid onto the shift lever from above and below. Because of their identical shapes, which can be triangles, rectangles, or squares, the half-shells can be connected to one another. This connection is a form fit. Each of the two hemispheres at the joint area has the aforementioned identical shape as the other. This arrangement prevents the hemispheres from shifting with respect to one another. Preferably, the half-shells have identical parts at their rims that can be inserted into one another and have a connection that can move along the shaft of the shift lever to compensate for backlash in the axial direction. To accomplish the cushioning between the two half-shells, there is clearance for backlash compensation in the axial direction in the contour. The half-shells should beneficially be made of plastic, preferably polyacetal.

After the two half-shells are put together around the bearing ball, the split bearing shells can be closed around the hemispheres surrounding the bearing ball. The bearing shell for the bearing ball is made of two parts that are split parallel or essentially lengthwise to the shaft of the manual gearshift lever. The half-shells of the bearing can advantageously be connected to one another by a hinge, which greatly simplifies installation. The hinge can represent a simple plastic connector or a tape. There is a cushion on the inside of each bearing half-shell. This cushion is made of a thermoplastic polyurethane (TPU) rubber that is vulcanized and is introduced into the bearing shells by a suitable method.

The two bearing shells are closed around the bearing ball and are then introduced together with the manual shift lever into the mount of the gearshift housing provided for them. If the shape of the bearing shells is cylindrical, the part of the gearshift housing into which they are introduced also conforms to this cylindrical shape. To guarantee bearing security, both the gearshift housing and each half-shell contain connector elements that engage with one another. In the simplest case they can be ratchet lugs that engage in the gearshift housing in windows of the molded part. It is advantageous, for example, to place four windows in a cylindrical component and four ratchet lugs on two half-shells.

It is advantageous to make the split bearing shells of plastic, preferably polyamide. Of course, other suitable plastics are possible. In accordance with the invention, cushioned bearing shells of a manual gearshift lever may be installed in a housing, and disassembled as the case may be, quickly and in a simple manner with little effort. Fastening by screws or lids are no longer necessary.

### BRIEF DESCRIPTION OF THE DRAWINGS

Other objects and features of the present invention will become apparent from the following detailed description considered in connection with the accompanying drawings. It should be understood, however, that the drawings are designed for the purpose of illustration only and not as a definition of the limits of the invention.

In the drawings, wherein similar reference characters denote similar elements throughout the several views:

FIG. 1 shows a cushioned bearing shell for a manual gearshift lever in a longitudinal section;

FIG. 2 shows a shows a cushioned bearing shell for a manual gearshift lever with split bearing shells and a gearshift housing in a cross section;

FIG. 3 is an assembly view of the cushioned bearing shell for the manual gearshift lever.

### DETAILED DESCRIPTION OF PREFERRED EMBODIMENTS

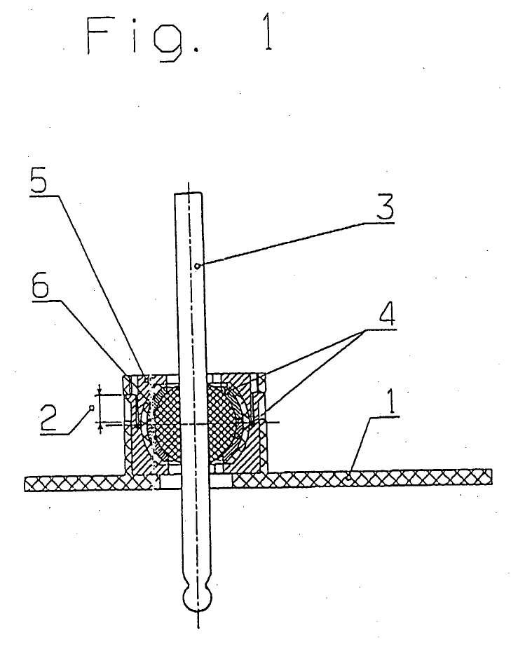

FIG. 1 shows a gearshift housing 1 and a manual gearshift lever 3 with a bearing ball. Around the bearing ball on the manual gearshift lever are placed the bearing half-shells 4 that are encircled on both sides by split bearing shells 5. Inside split bearing shells 5 is rubber (TPU) cushioning 6. On the outside of bearing shells 5 are ratchet lugs 8. Split bearing shells 5 are held together by the cylindrical form of gearshift housing 1, which has windows 2 for ratchet lugs 8 of split bearing shells 5.

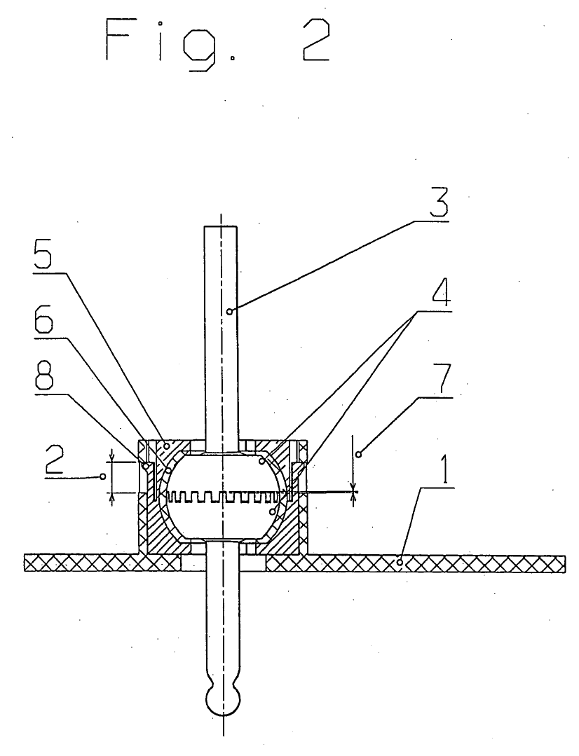

FIG. 2 shows ratchet lugs 8 that engage in windows 2, with clearance for backlash compensation 7 of half-shells 4 in the axial direction. The half-shells 4 of the bearing are connected to one another by a suitable form, in this case a square form.

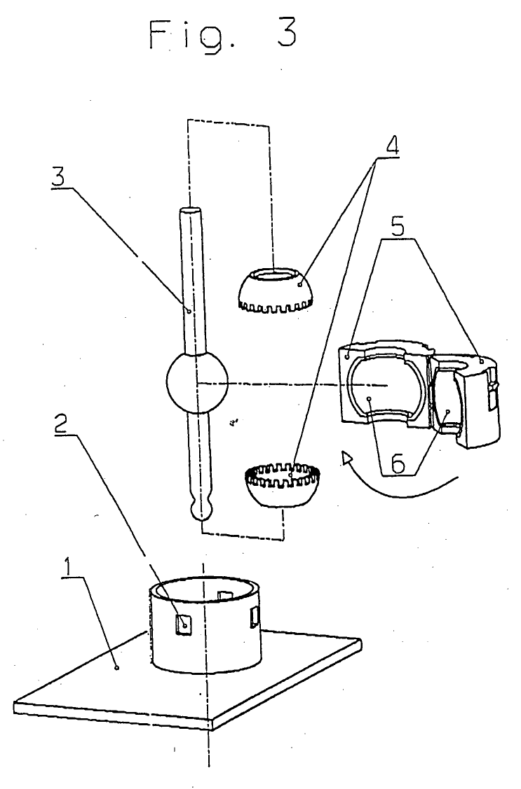

FIG. 3 shows the individual components before they are assembled. The half-shells, which have teeth as connection elements in their centers, are applied to manual gearshift lever 3 from both ends, top and bottom. When these two parts 4 are joined to one another, split bearing shells 5 are folded around the bearing ball, with a plastic hinge being placed between parts 5, and the inner surface on which the bearing ball moves is provided with rubber cushioning 6. After the split bearing shells are folded around half-shells 4, they are introduced into the cylindrical gearshift housing, with ratchet lugs 8 engaging in windows 2. The proposed method represents the possibility of simple and quick assembly, especially for manufacturers of manual gearshift levers who install them and supply them with their housing. This method would also provide an alternative for servicemen who have an interest in fast disassembly of the mechanism, for disassembling the shift lever quickly and easily with few tools.

Although at least one embodiment of the present invention has been shown and described, it is to be understood that many changes and modifications may be made thereon to without departing from the spirit and scope of the invention as defined in the appended claims.

What is claimed is:

1. An assembly comprising
(a) a manual gearshift lever having a shaft;
(b) a first enclosure comprising first and second cushioned half-shells surrounding a bearing ball, said first enclosure being split into said first and second half-shells transverse to the shaft of the manual gearshift lever;
(c) a second enclosure comprising first and second split bearing shells surrounding the bearing ball and half-shells, said second enclosure being split into said first and second split bearing shells substantially lengthwise to the shaft of the manual gearshift lever; and
(d) a gearshift housing for holding firmly together within said gearshift housing the split bearing shells fitted with the manual gearshift lever, the bearing ball and the half-shells, the manual gearshift lever being pivotable around the bearing ball.

2. The assembly according to claim 1, wherein the half-shells are made of plastic.

3. The assembly according to claim 2, wherein the half-shells are made of a polyacetal plastic.

4. The assembly according to claim 1, wherein the half-shells are joined to one another with a form fit.

5. The assembly according to claim 1, wherein the half-shells comprise respective identical rim parts insertable into each other to form a movable connection along the shaft of the manual gearshift to compensate for backlash in an axial direction.

6. The assembly according to claim 1, wherein the split bearing shells have a hinge lengthwise of the shaft of the manual gearshift lever.

7. The assembly according to claim 1, wherein the split bearing shells have interiors with rubber cushioning.

8. The assembly according to claim 1, wherein the split bearing shells have exterior ratchet lugs.

9. The assembly according to claim 1, wherein the split bearing shells are made of plastic.

10. The assembly according to claim 9, wherein the split bearing shells are made of a polyamide plastic.

11. The assembly according to claim 8 further comprising a plurality of windows in the gearshift housing for the ratchet lugs of the split bearing shells.
